(19) United States
(12) Patent Application Publication
(10) Pub. No.: US 2016/0347647 A1
(43) Pub. Date: Dec. 1, 2016

(54) REINFORCED GLASS AND GLASS-TO-BE-TREATED FOR REINFORCED GLASS

(71) Applicant: Asahi Glass Company, Limited, Chiyoda-ku (JP)

(72) Inventors: Shin-ichi AMMA, Tokyo (JP); Madoka ONO, Tokyo (JP)

(73) Assignee: Asahi Glass Company, Limited, Chiyoda-ku (JP)

(21) Appl. No.: 15/232,141

(22) Filed: Aug. 9, 2016

Related U.S. Application Data
(63) Continuation of application No. PCT/JP2015/053222, filed on Feb. 5, 2015.

(30) Foreign Application Priority Data
Feb. 14, 2014 (JP) 2014-026810

(51) Int. Cl. C03C 3/087; C03C 23/00; C03C 4/02; C03C 3/076; C03C 3/083

(52) U.S. Cl. CPC C03C 3/087; C03C 3/076; C03C 3/083; C03C 4/02; C03C 23/007; C03C 2204/00

(57) ABSTRACT

The present invention relates to a strengthened glass obtained by strengthening a glass to be treated which the glass to be treated contains, as expressed in mole percentage on an oxide basis, from 2% to 15% of Fe₂O₃ or from 5% to 15% of TiO₂, has a glass transition point of from 450° C. to 650° C. and has a maximum thermal expansion coefficient αₘₐₓ of 430×10⁻⁷/° C. or above in a temperature range between the glass transition point and a yield point.

### TECHNICAL FIELD

The present invention relates to a strengthened glass and glass to be treated for strengthening processing, and more specifically, the present invention relates to a thin-type strengthened glass which is characterized as having a black hue.

### BACKGROUND ART

A strengthened glass is glass overcoming a drawback of being prone to breakage, which is a problem of general glass, and it has been used for transport machinery, architecture and so on. Examples of transport machinery include a passenger car, a truck, a bus, a rail car, a ship, and an aircraft, and the strengthened glass is used for windows, head lights, tail lights, and so on. On the other hand, examples of architecture include a building and a house, and the strengthened glass is used for windows, doors, partitions, and so on. In addition, the strengthened glass has been widely used in furniture such as a bookshelf and a showcase, an electric appliance, an office appliance, and so on.

Furthermore, it is being contemplated to adopt glass having a black hue for transport machinery, for example, as a privacy protection glass of car, and for architecture use as a wall material and a decoration material such as a partition. In addition, it has recently been studied to adopt the glass having a black hue as cases or touch panels of smartphones, tablet PCs or the like by utilizing its characteristics of suitability to be designed, design quality, scratch resistance, and so on.

A strengthened glass can be manufactured by a method referred to as thermal strengthening or chemical strengthening. The thermal strengthening is a method utilizing thermal shrinkage of glass under cooling, and glass is heated up to a temperature in the vicinity of its softening point or yield point, and then subjected to cooling. During the cooling, the temperature drop at the surface of glass is faster than that of the inside of the glass, and hence there occurs a temperature difference in the thickness direction of glass to result in creation of tensile stress at the surface and compressive stress in the inside, and due to the inversion based on a stress relaxation phenomenon induced thereafter, the compressive stress appears and remains at the surface, while the tensile stress appears and remains inside. The compressive stress remaining at the surface makes it possible to enhance the strength and improve abrasion resistance by suppressing crack growth. As a typical example of the thermal strengthening, mention may be made of a method for tempering by air-cooling, in which a plate glass is manufactured in a float process or the like, a cut glass plate is heated up to a temperature in the vicinity of its softening point or yield point, and then its surface is subjected to quenching by blasting air as a cooling medium.

In recent years, reduction in weight of a strengthened glass has been required in various uses, such as uses in transport machinery and uses in architecture. Expectations for weight reduction have also grown with respect to a strengthened glass having a black hue, and once the reduction in weight of such glass has been attained, the range of uses will be enlarged. The strengthened glass can achieve its weight reduction by reducing its thickness. Accordingly, for example, in the case of uses in transport machinery or architecture, it is demanded of the strengthened glass to reduce its thickness to 2.5 mm or below. However, because the thermal strengthening utilizes a temperature difference between the surface and the inside of glass under cooling, small thickness makes it impossible to achieve a large temperature difference between the surface and the inside, and thus, substantial strengthening becomes difficult.

As to the method for manufacturing a strengthened glass having a small thickness, for example, it is known to use a glass composition having specified constituents and having an average linear thermal expansion coefficient at 50° C. to 350° C. of 80×10⁻⁷/° C. to 110×10⁻⁷/° C. (see e.g. Patent Document 1). However, according to such a manufacturing method, the average linear thermal expansion coefficient is only controlled on the lower-temperature side, and hence residual stress cannot always be effectively imparted to a thin glass having a thickness of 2.5 mm or below.

As another method for manufacturing a strengthened glass having a small thickness, for example, there is known a two-stage cooling method in which a shock-wave generation air having a specified thermal conductance is made to blow, and further an air having a specified thermal conductance is made to blow (see e.g. Patent Document 2). However, according to such a method, there arises the necessity for providing usual piping with additional mechanisms including open and pressure-control mechanisms in order to generate shock waves; as a result, such mechanisms cause a considerable rise in manufacturing costs as compared with a usual manufacturing facility.

### PRIOR ART DOCUMENTS

### Patent Documents

Patent Document 1: JP-A-2003-119048

Patent Document 2: JP-B-H06-23068

### SUMMARY OF THE INVENTION

### Problems that the Invention is to Solve

As mentioned above, thickness reduction has been required of a strengthened glass having a black hue from the viewpoint of achieving weight reduction. From the viewpoint of manufacturing costs also, it has been demanded that such glass be manufactured without making large changes in a traditional manufacturing facility. For example, in the strengthening utilizing air-cooling, though it becomes easy to impart residual stress to a thin glass as well by blowing a shock-wave generation air or increasing the velocity pressure of air blow, manufacturing costs are apt to increase because it becomes necessary to make changes in the manufacturing facility.

The present invention has been made in order to solve the foregoing problems. Objects of the present invention are to provide a strengthened glass having a small thickness and a black hue which can be manufactured through the strengthening by general air-cooling without requiring any particular manufacturing facility; and to provide a glass which is to be treated for strengthening processing and suitable for manufacturing of such a strengthened glass.

### Means for Solving the Problems

The strengthened glass according to the present invention is a strengthened glass obtained by strengthening a glass to be treated, which contains, as expressed in mole percentage on an oxide basis, from 2% to 15% of Fe₂O₃ or from 5% to 15% of TiO₂, has a glass transition point of from 450° C. to 650° C. and has a maximum thermal expansion coefficient αₘₐₓ of 430×10⁻⁷/° C. or above in a temperature range between the glass transition point and a yield point.

Furthermore, the glass to be treated according to the present invention is a glass to be treated for a strengthened glass, containing, as expressed in mole percentage on an oxide basis, from 55% to 80% of SiO₂, from 0 to 15% of Al₂O₃, from 0.1% to 10% of MgO, from 0.1% to 10% of CaO, from 0 to 8% of SrO, from 0 to 5% of BaO, from 8% to 25% of Na₂O, from 0.1% to 4% of K₂O, and further from 2% to 15% of Fe₂O₃ or from 5% to 15% of TiO₂.

### Advantage of the Invention

According to the strengthened glass of the present invention, in particular, a glass to be treated, containing, as expressed in mole percentage on an oxide basis, from 2% to 15% Fe₂O₃ or from 5% to 15% of TiO₂, having a glass transition point of from 450° C. to 650° C. and having a maximum thermal expansion coefficient αₘₐₓ of 430×10⁻⁷/° C. or above in a temperature range between the glass transition point and its yield point is used. Through the use of such a glass to be treated, it becomes possible to manufacture a thin-type strengthened glass having a black hue by performing a general strengthening utilizing air-cooling without the need for providing any particular manufacturing facility.

### BRIEF DESCRIPTION OF THE DRAWINGS

FIG. 1 is a perspective view illustrating an example of forming apparatus applicable to a manufacture of a strengthened glass according to an embodiment.

FIG. 2 is a perspective view illustrating an example of a strengthening device utilizing air-cooling, applicable to a manufacture of a strengthened glass according to an embodiment.

FIG. 3 is a plan view illustrating the arrangement of cooling nozzles in Examples.

### MODES FOR CARRYING OUT THE INVENTION

Embodiments of the present invention are illustrated below. Additionally, the term “glass to be treated” refers to glass before receiving treatment for strengthening.

A strengthened glass according to embodiments can be obtained through a heating process and a cooling process. In the heating process, heat treatment is given to a glass to be treated which contains, as expressed in mole percentage on an oxide basis, 2% to 15% of Fe₂O₃ or 5% to 15% of TiO₂, has a glass transition point of from 450° C. to 650° C. and has a maximum thermal expansion coefficient αₘₐₓ of 430×10⁻⁷/° C. or above in a temperature range between the glass transition point and yield point. In the cooling process, air-cooling treatment is given to the glass to be treated. Hereinafter, the maximum thermal expansion coefficient αₘₐₓ in a temperature range between glass transition point and yield point is simply abbreviated to high-temperature thermal expansion coefficient (αₘₐₓ).

As for the strengthened glass (i.e., strengthened glass plate; the same shall apply hereinafter) according to embodiments, the glass used as the glass to be treated (i.e., glass plate to be treated; the same shall apply hereinafter) in strengthening utilizing air-cooling is a glass having a glass transition point of from 450° C. to 650° C. and a high-temperature thermal expansion coefficient (αₘₐₓ) of 430×10⁻⁷/° C. or above.

To such a glass to be treated, residual stress can be effectively imparted by air-cooling treatment under a velocity pressure of 30 kPa or below even in the case where the glass has a thickness of 2.5 mm or below. The velocity pressure of 30 kPa or below, which is specified herein, is a velocity pressure which can be achieved by commonly-used strengthening devices utilizing air-cooling. In other words, according to a strengthened glass of embodiments, a thin-type strengthened glass having a thickness of 2.5 mm or below can be manufactured by means of a commonly-used strengthening device utilizing air-cooling.

The glass to be treated according to the present invention contains, as expressed in mole percentage on an oxide basis, 2% to 15% of Fe₂O₃ or 5% to 15% of TiO₂. In the case where the Fe content therein is lower than 2% in terms of Fe₂O₃, the glass obtained is unsatisfactory in black hue. The Fe content in terms of Fe₂O₃ is preferably 2.5% or higher, more preferably 3% or higher and further preferably 4% or higher. In the case where the Ti content therein is lower than 5% in terms of TiO₂, the glass obtained is unsatisfactory in black hue. The Ti content in terms of TiO₂ is preferably 6% or higher, more preferably 7% or higher and further preferably 8% or higher. In the case where the Fe content therein is higher than 15% in terms of Fe₂O₃, the glass obtained has a high probability of crystallization, and becomes unsuitable for various uses. The Fe content in terms of Fe₂O₃ is preferably 12.5% or lower, more preferably 10% or lower and further preferably 8% or lower. Also in the case where the Ti content in terms of TiO₂ is higher than 15%, the glass obtained has a high probability of crystallization, and becomes unsuitable for various uses. The Ti content in terms of TiO₂ is preferably 14% or lower, more preferably 13% or lower and further preferably 11% or lower.

In addition, Fe has an effect of heightening a high-temperature thermal expansion coefficient (αₘₐₓ). Moreover, because Fe is a component capable of absorbing heat waves, it can promote thermal convection of fused glass to enhance the homogeneity of the glass, and besides, it has an effect of, for example, increasing the longevity of a melting furnace by preventing the bottom bricks in the melting furnace from being heated overly. Furthermore, TiO₂ also has the effect of heightening a high-temperature thermal expansion coefficient (αₘₐₓ). In the case of incorporating only one of the two elements Fe and Ti into the glass, incorporation of Fe is preferable because Fe is greater in the effect of heightening a high-temperature thermal expansion coefficient (αₘₐₓ).

In the case where the glass to be treated has a glass transition point of higher than 650° C., it becomes necessary to heat the glass up to a high temperature during the heating process; as a result, surrounding members holding the glass to be treated or the like are exposed to the high temperature to induce a concern that their life span might be markedly shorten, and hence extension of life span requires using expensive members superior in heat resistance. On the other hand, in the case where the glass to be treated has a glass transition point of lower than 450° C., it is difficult to make a temperature difference between the surface and the inside through the heating process and the cooling process, and residual stress cannot be effectively imparted to the glass. The glass transition point of the glass to be treated is from 450° C. to 650° C., preferably from 450° C. to 645° C., more preferably from 450° C. to 640° C., further preferably from 460° C. to 640° C., still further preferably from 480° C. to 620° C., and far preferably from 500° C. to 600° C.

The yield point of the glass to be treated is not necessarily limited, but it is preferably higher than 500° C. In the case where the yield point is 500° C. or lower, the heating temperature during the heating process, namely the strengthening start temperature, becomes low and induces a concern that residual stress could not be effectively imparted to the glass. The yield point is preferably 750° C. or lower. In the case where the yield point is higher than 750° C., it becomes necessary to heat the glass up to a high temperature during the heating process; as a result, surrounding members holding the glass to be treated or the like are exposed to the high temperature to induce a concern that their life span might be markedly shorten, and hence extension of life span requires using expensive members superior in heat resistance. The yield point of the glass to be treated is preferably 740° C. or lower, more preferably 730° C. or lower and further preferably 720° C. or lower, while it is preferably 510° C. or higher and more preferably 520° C. or higher.

In the case where the high-temperature thermal expansion coefficient (αₘₐₓ) is lower than 430×10⁻⁷/° C., there is a concern that residual stress could not be effectively imparted to a thin-type glass to be treated, which has a thickness of 2.5 mm or below, by the air-cooling treatment under a velocity pressure of 30 kPa or below. In general, strengthening utilizing air-cooling is performed by quenching from a temperature higher than the glass transition point by 100° C. or so. By adjusting the high-temperature thermal expansion coefficient (αₘₐₓ) to 430×10⁻⁷/° C. or higher and starting the air-cooling treatment under a velocity pressure of 30 kPa or lower from such a high temperature as specified above, residual stress can be effectively imparted to a thin-type glass to be treated, which has a thickness of 2.5 mm or below. The high-temperature thermal expansion coefficient (αₘₐₓ) is preferably 500×10⁻⁷/° C. or higher, more preferably 600×10⁻⁷/° C. or higher, further preferably 650×10⁻⁷/° C. or higher, and particularly preferably 700×10⁻⁷/° C. or higher.

The “high-temperature thermal expansion coefficient (αₘₐₓ)” as used herein refers to the maximum value of thermal expansion coefficients in a section between glass transition point and yield point on an expansion coefficient curve of the glass to be treated, which is measured with a thermal dilatometer as mentioned below. The higher the high-temperature thermal expansion coefficient (αₘₐₓ) is, the more preferable it is in view of imparting residual stress. However, the high-temperature thermal expansion coefficient (αₘₐₓ) of 1,000×10⁻⁷/° C. at most is quite sufficient in usual cases. In addition, an increase in the high-temperature thermal expansion coefficient (αₘₐₓ) may cause a concern that cracks might be produced in the glass due to temporary distortion occurring in an early stage of the cooling process to result in deterioration of yield factor. Therefore, the high-temperature thermal expansion coefficient (αₘₐₓ) is preferably 1,000×10⁻⁷/° C. or lower, more preferably 950×10⁻⁷/° C. or lower, and further preferably 900×10⁻⁷/° C. or lower.

Furthermore, as to the glass to be treated, its thermal expansion coefficient difference (Δα(=αₘₐₓ−α)) between the high-temperature thermal expansion coefficient (αₘₐₓ) and the average linear expansion coefficient (α) in a temperature range between 50° C. and 350° C. is preferably 320×10⁻⁷/° C. or greater. In the case where thermal expansion coefficients over a range of from low temperature to high temperature are simply increased, that is, in the case where the high-temperature thermal expansion coefficient (αₘₐₓ) and the average linear expansion coefficient (α) are simply increased, cracking due to thermal shock, a thermal expansion mismatch between the glass and other members, incompatibility with the currently-used process, and the like tend to occur during the heating process and cooling process.

By adjusting the thermal expansion coefficient difference (Δα) to 320×10⁻⁷/° C. or greater, in other words by making the high-temperature thermal expansion coefficient (αₘₐₓ) relatively high while keeping the average linear expansion coefficient α at a constant value, not only residual stress can be effectively imparted to a thin-type glass to be treated, which has a thickness of 2.5 mm or below, through the air-cooling treatment under a velocity pressure of 30 kPa or below, but also occurrence of cracking due to thermal shock or the like can be suppressed. The thermal expansion coefficient difference (Δα) is preferably 360×10⁻⁷/° C. or greater, more preferably 370×10⁻⁷/° C. or greater, further preferably 400×10⁻⁷/° C. or greater, and still preferably 450×10⁻⁷/° C. or greater. Basically, the greater the thermal expansion coefficient difference (Δα) is, the more preferable it is. However, the thermal expansion coefficient difference (Δα) of 500×10⁻⁷/° C. at most is quite sufficient in usual cases.

The higher the average linear expansion coefficient (α) is, the more preferable it is in view of imparting residual stress. However, too high average linear expansion coefficient (α) brings about possibilities that an expansion mismatch problem will develop between the glass and currently-used other members and the glass will become susceptible to thermal shock. Accordingly, the average linear expansion coefficient α is preferably from 80×10⁻⁷/° C. to 120×10⁻⁷/° C., more preferably from 85×10⁻⁷/° C. to 115×10⁻⁷/° C., further preferably from 85×10⁻⁷/° C. to 113×10⁻⁷/° C., still further preferably from 85×10⁻⁷/° C. to 110×10⁻⁷/° C., and furthermore preferably from 88×10⁻⁷/° C. to 110×10⁻⁷/° C.

Herein, a glass transition point, a yield point and thermal expansion coefficients (αₘₐₓ and α) are measured by the following procedure. That is, a columnar sample having a diameter of 5 mm and a length of 20 mm is prepared, thermal expansion thereof is measured by using a thermal dilatometer under conditions that the load is 10 g and the temperature rising speed is 5° C./min, and thereby the glass transition point, yield point and thermal expansion coefficients (αₘₐₓ and α) are determined.

The glass to be treated is preferably one containing, as expressed in mole percentage on an oxide basis, from 55% to 80% of SiO₂, from 0 to 15% of Al₂O₃, from 0.1% to 10% of MgO, from 0.1% to 10% of CaO, from 0 to 8% of SrO, from 0 to 5% of BaO, from 8% to 25% of Na₂O, and from 0.1% to 4% of K₂O, and further from 2% to 15% of Fe₂O₃ or from 5% to 15% of TiO₂. Hereafter, the mole percentage on an oxide basis is also denoted simply as % or mol %.

According to such a composition as recited above, the basic constituents (items of basic elements) thereof are the same as the constituents (items of elements constituting the composition) of a soda lime glass used generally in manufacturing of a strengthened glass, and hence the productivity becomes satisfactory.

In addition, according to such a composition, the glass having a glass transition point of from 450° C. to 650° C. and having a high-temperature thermal expansion coefficient (αₘₐₓ) of 430×10⁻⁷/° C. or higher can be obtained. The range of proportions of each constituent in the composition is explained below.

The SiO₂ content is preferably from 55% to 80%. In the case where the SiO₂ content is lower than 55%, there is a concern of causing problems such as an increase in glass density, an increase in thermal expansion coefficient and degradation in scratch resistance. The SiO₂ content is preferably 57% or higher, and more preferably 60% or higher. In the case where the SiO₂ content is higher than 80%, the viscosity becomes high, and there is a concern that the glass becomes difficult to melt. The SiO₂ content is preferably 75% or lower, more preferably 72% or lower, further preferably 71% or lower, and particularly preferably 70% or lower.

Al₂O₃ can be incorporated as required, and the preferred content thereof is 15% or lower. In the case where the Al₂O₃ content is higher than 15%, it is difficult to increase the thermal expansion coefficient at a temperature equal to or higher than the glass transition point, and hence there is a concern that the residual stress might be difficult to be increased. Accordingly, the Al₂O₃ content is preferably 13% or lower, more preferably 11% or lower, further preferably 10% or lower, and particularly preferably 9% or lower. Additionally, incorporation of Al₂O₃ allows enhancement of weather resistance of the glass. The Al₂O₃ content is preferably 0.1% or higher, more preferably 0.5% or higher and further preferably 0.9% or higher.

The MgO content is preferably 0.1% or higher. MgO is required for maintaining the thermal expansion coefficient in moderation, and further can enhance scratch resistance. The MgO content is preferably 2% or higher and more preferably 3% or higher. On the other hand, it is preferred that the MgO content be 10% or lower. In the case where the MgO content is higher than 10%, the glass comes to have a strong tendency toward devitrification, and there is a concern of decline in productivity. Accordingly, the MgO content is preferably 8% or lower, more preferably 7% or lower and further preferably 6% or lower.

The CaO content is preferably 0.1% or higher. CaO is required for maintaining the thermal expansion coefficient in moderation. The CaO content is preferably 2% or higher and more preferably 3% or higher. On the other hand, it is preferred that the CaO content be 10% or lower. In the case where the CaO content is higher than 10%, the glass comes to have a strong tendency toward devitrification, and there is a concern of decline in productivity. Accordingly, the CaO content is preferably 8% or lower, more preferably 7% or lower and further preferably 6% or lower.

SrO can be incorporated as required, and the preferred content thereof is 8% or lower. Incorporation of SrO allows adjustments to meltability and the thermal expansion coefficient of the glass at high temperature. In the case where the SrO content is higher than 8%, the glass density becomes high, and there is concern of a gain in glass weight. In the case of incorporating SrO, the SrO content is preferably 0.1% or higher, more preferably 0.9% or higher, further preferably 1% or higher, and still more preferably 1.5% or higher. And the SrO content is preferably 7% or lower, more preferably 6% or lower and further preferably 5% or lower.

BaO can be incorporated as required, and the preferred content thereof is 5% or lower. Incorporation of BaO allows adjustments to meltability and the thermal expansion coefficient of the glass at high temperature. In the case of incorporating BaO, the BaO content is preferably 0.1% or higher, more preferably 0.5% or higher and further preferably 0.9% or higher. On the other hand, the incorporation BaO heightens the glass density, and tends to cause a gain in glass weight. Additionally, the incorporation of BaO makes the glass fragile, and thereby the crack initiation load of the glass becomes low and the glass becomes susceptible to damage. Therefore, the BaO content is preferably 5% or lower, more preferably 3% or lower, further preferably 2% or lower, and still more preferably 1% or lower.

The Na₂O content is preferably 8% or higher. Na₂O is a constituent by which the thermal expansion coefficient is heightened even in the case where the glass density is low, and hence Na₂O is incorporated in the glass composition for the purpose of adjusting the thermal expansion coefficient. The Na₂O content is preferably 9% or higher, more preferably 10% or higher, further preferably 11% or higher, and particularly preferably 12% or higher. On the other hand, it is preferred that the Na₂O content be 25% or lower. In the case where the Na₂O content is higher than 25%, the temperature difference between strain point and yield point becomes small, and thereby strengthening stress becomes weak, and there is a concern of an excess increase in thermal expansion coefficient. Accordingly, the Na₂O content is preferably 23% or lower, more preferably 21% or lower, further preferably 18% or lower, and particularly preferably 15% or lower.

K₂O can be incorporated as required, and the preferred content thereof is 0.1% or higher. In the case where the K₂O content is 0.1% or higher, meltability and moderate thermal expansion coefficient of the glass at high temperature can be maintained. The K₂O content is preferably 0.5% or higher and particularly preferably 1% or higher. On the other hand, it is preferred that the K₂O content be 4% or lower. In the case where the K₂O content is higher than 4%, the glass density becomes high, and there is a concern of a gain in glass weight. Accordingly, the K₂O content is preferably 3.5% or lower and more preferably 3% or lower.

It is preferred that the glass to be treated be substantially made up of the foregoing constituents, but other constituents may be incorporated in a total proportion up to 10% as the need arises so long as the incorporation thereof does not go against the purport of the present invention. The total proportion of the other constituents is preferably 8% or lower, more preferably 5% or lower and further preferably 3% or lower. Examples of the other constituents include ZrO₂, Y₂O₃, CeO₂, MnO, and CoO. In addition, B₂O₃, PbO, Li₂O and so on can also be incorporated, but it is preferable that they be not incorporated in a substantial sense. The wording “not incorporated in a substantial sense” means “not incorporated, with the exceptions of inevitable impurities”. The same shall apply hereinafter.

For example, in the case where the glass composition contains B₂O₃, the high-temperature thermal expansion coefficient (αₘₐₓ)can also be heightened up to some extent. However, it is preferred that B₂O₃ be not incorporated in a substantial sense, because detoxification is apt to require a considerable cost, the constituent is vaporized by heating to likely make the composition unstable, the raw material cost is high, and so on.

Furthermore, as a clarifying agent used at the time of melting of the glass, the glass to be treated may contain SO₃, chlorides, fluorides, halogens, SnO₂, Sb₂O₃, As₂O₃, or the like where deemed appropriate. The content of such a substance is preferably 0.01% or higher, more preferably 0.1% or higher and further 0.2% or higher, while it is preferably 3% or lower, more preferably 2.5% or lower and further preferably 2% or lower. Furthermore, for the purpose of adjustment in hue, Ni, Cr, V, Se, Au, Ag, Cd, and the like may be incorporated. The content of such a metal is preferably 0.1% or higher, more preferably 0.2% or higher and further preferably 0.5% or higher, while it is preferably 3% or lower, more preferably 2.5% or lower and further preferably 2% or lower. On the other hand, it is preferred that none of As, Sb and Pb be incorporated in a substantial sense into the glass to be treated. Because these metals have toxicity, their absence in the glass to be treated is desirable from the viewpoint of preventing adverse effects on the environment. It is preferable that the values of their content be lower than 0.01%.

According to the present invention, the glass to be treated can be made to have a thickness of 2.5 mm or thinner. By reducing the thickness to 2.5 mm or thinner, it becomes possible to obtain a light-weight strengthened glass. In addition, according to the strengthened glass of the embodiment, even in the case where the glass to be treated is 2.5 mm or thinner in thickness, residual stress can be effectively imparted thereto by air-cooling treatment under a velocity pressure of 30 kPa or below. The thickness of the glass to be treated does not necessarily have limits so long as it is 2.5 mm or thinner, but from the viewpoint of reduction in weight, the thickness of 2.4 mm or thinner is preferable, 2.3 mm or thinner is more preferable, 2.2 mm or thinner is further preferable, and 2 1 mm or thinner is especially preferable. In addition, from the viewpoint of effectively imparting residual stress by strengthening treatment of strengthening utilizing air-cooling, it is preferred that the thickness of the glass to be treated be 1.3 mm or thicker. And the thickness of the glass to be treated is preferably 1.6 mm or thicker, and more preferably 1.7 mm or thicker. Additionally, it is also possible to manufacture a desired strengthened glass from glass to be treated which is over 2.5 mm in plate thickness by giving the same strengthening treatment as in the present invention.

Incidentally, the glass to be treated according to the present invention is to receive strengthening by heat treatment as its principal aim. However, the glass to be treated can also be strengthened by applying chemical treatment to provide glass having a sufficient strength.

The glass to be treated is manufactured by any method of the glass plate forming methods including a float process, a fusion process, a download process, a roll-out process, and the like. A float process can make it easy to manufacture glass plates with large areas and reduce a thickness deviation, and hence is preferred.

In the process of cooling, air-cooling treatment is carried out. For example, by blowing cooling air with a velocity pressure of 30 kPa or below in both surfaces of the glass to be treated which has undergone heat treatment, to thereby quenching the glass, a strengthened glass is obtained. The velocity pressure is preferably 27 kPa or below and more preferably 25 kPa or below. Even under such a velocity pressure, residual stress can be effectively imparted by adopting the method for manufacturing a strengthened glass according to an embodiment. In addition, such a velocity pressure allows the use of a variety of strengthening devices utilizing air-cooling. From the viewpoint of effectively imparting residual stress, the velocity pressure is preferably 15 kPa or higher and more preferably 20 kPa or higher.

In addition, in the case where the residual stress which the strengthened glass after strengthening has is adjusted to 120 MPa or higher, it becomes possible for the strengthened glass to have sufficiently enhanced strength. The residual stress is preferably 130 MPa or higher, more preferably 150 MPa or higher and further preferably 170 MPa or higher.

As a strengthening device utilizing air-cooling, use can be made of conventional strengthening devices utilizing air-cooling which are used for air-cooling-strengthening of this type. Examples of such a device include a strengthening device utilizing air-cooling in which a glass to be treated is placed between upper and lower nozzle members for air-cooling-strengthening so as to be sandwiched with a predetermined spacing and quenched with cooling air. The strengthening device utilizing air-cooling is illustrated below with one of embodiments.

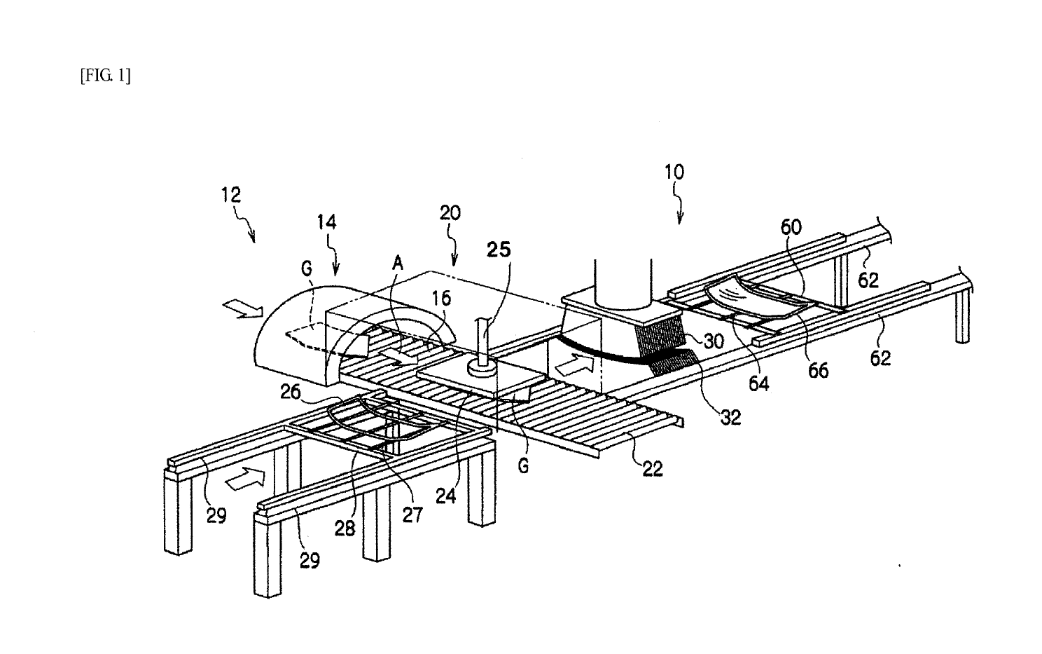

FIG. 1 is a perspective view illustrating one example of the overall structure of a glass plate forming apparatus including a strengthening device utilizing air-cooling applicable to manufacture of a strengthened glass according to an embodiment. By the way, this glass plate forming apparatus is a bending and forming apparatus for a rear glass of cars.

The glass plate forming apparatus 12 is an in-furnace bending and forming apparatus to carry out bending and forming of a glass plate G as the glass to be treated on the inside of the heating section 14, but it is also applicable to out-of-furnace bending and forming apparatus in which the glass plate G undergoes bending and forming on the outside of the heating section 14. Additionally, the use for the glass plate G having undergone bending and forming is not limited to the use as a rear glass of cars, but it may be a use as a front glass or a side glass of cars, and is not limited to the use for cars.

In the heating section 14, a roller conveyor 16 is installed. While being transported within the heating section 14 by a roller conveyor 16 in the direction of the arrow A on FIG. 1, the glass plate G to undergo bending and forming is heated up to a predetermined bending and forming temperature in the course of being transported inside the heating section 14. At the exit of the heating section 14, a forming furnace 20 is provided, and the inside of the forming furnace 20 communicates with the heating section 14, and thereby it is kept in a high-temperature state. The glass plate G heated up to the bending and forming temperature in the heating section 14 is carried into the forming furnace 20 by means of the roller conveyor 22. The heating process in the method for manufacturing a strengthened glass according to an embodiment is performed by the use of, for example, these heating section 14 and forming furnace 20.

On the inside of the forming furnace 20, a shaping die 24 is provided. The shaping die 24 is provided within the forming furnace 20 in a state of being suspended with four pendant rods (not illustrated in FIG. 1) from the side of the ceiling of the forming furnace 20. On the bottom surface of the shaping die 24 is formed a forming face in almost the same shape as the bending shape of the glass plate G to be formed.

In addition, the shaping die 24 is allowed to make up-and-down movements in the vertical direction by means of an elevating machine not illustrated. Furthermore, the top of the shaping die 24 is connected to an aspirating pipe 25. The aspirating pipe 25 is connected to a suction machine (not illustrated). Herein, the shaping die 24 has a plurality of aspiration holes (not illustrated) made in its shaping face, and through these aspiration holes air is sucked in. Thus the glass plate G is sucked and held on the shaping face.

Furthermore, downward the site of the shaping die 24 a lift jet (not illustrated) is provided underneath the roller conveyor 22. From the lift jet, hot air is made to spurt toward the glass plate G transported by the roller conveyor 22 to the position upward of the lift jet. By receiving this hot air, the glass plate G is floated over the roller conveyor 22, and this floating glass plate G is drawn and sucked to the shaping face of the shaping die 24, and then, the glass plate G is pressed between the shaping face and a bending ring 26, thereby undergoing bending and forming into a shape with a specified curvature.

This bending ring 26 has a peripheral shape nearly the same shape as the bent shape which the glass plate G is to be formed into, and is provided on a bending ring supporting flame 27. The bending ring supporting flame 27 is provided on a bending shuttle 28. The bending shuttle 28 is driven by a driving mechanism (not illustrated) and transported on a rail 29 in a reciprocating motion. By the reciprocating running of this bending shuttle 28, the bending ring 26 is shuttled back and forth between the forming position inside the forming furnace 20 and the standby position outside the forming furnace 20.

On the other hand, the strengthening device 10 utilizing air-cooling is provided with a quench shuttle 60. The quench shuttle 60 is placed across the forming furnace 20 from the bending shuttle 28, and driven by a driving mechanism (not illustrated) and transported on a rail 62 in a reciprocating motion. On the quench shuttle 60, a quench ring 66 is provided via a quench ring supporting flame 64.

The quench ring 66 is a tool for receiving the glass plate G having undergone bending and forming inside the forming furnace 20, and has a peripheral shape of a glass plate nearly the same shape as the bent shape which the curved glass plate is to be formed into. Through the travel of the quench shuttle 60, the quench ring 66 is shuttled back and forth between the receiving position inside the forming furnace 20 and the air-cooling-strengthening position outside the forming furnace 20. More specifically, when the bending ring 26 returns to the lateral standby position, a side door of the forming furnace 20, sited oppositely is opened and the quench shuttle 60 is made to travel from the outside of the furnace to the position underneath the shaping die 24. And the sucking of the glass plate G by the shaping die 24 is released, and thereby the glass plate G formed with the shaping die 24 is transferred onto the quench ring 66 and this glass plate G is transported to the strengthening device 10 utilizing air-cooling by means of the quench shuttle 60. The glass plate G strengthened by air-cooling in the strengthening device 10 utilizing air-cooling is transferred to the next process by means of the quench shuttle 60.

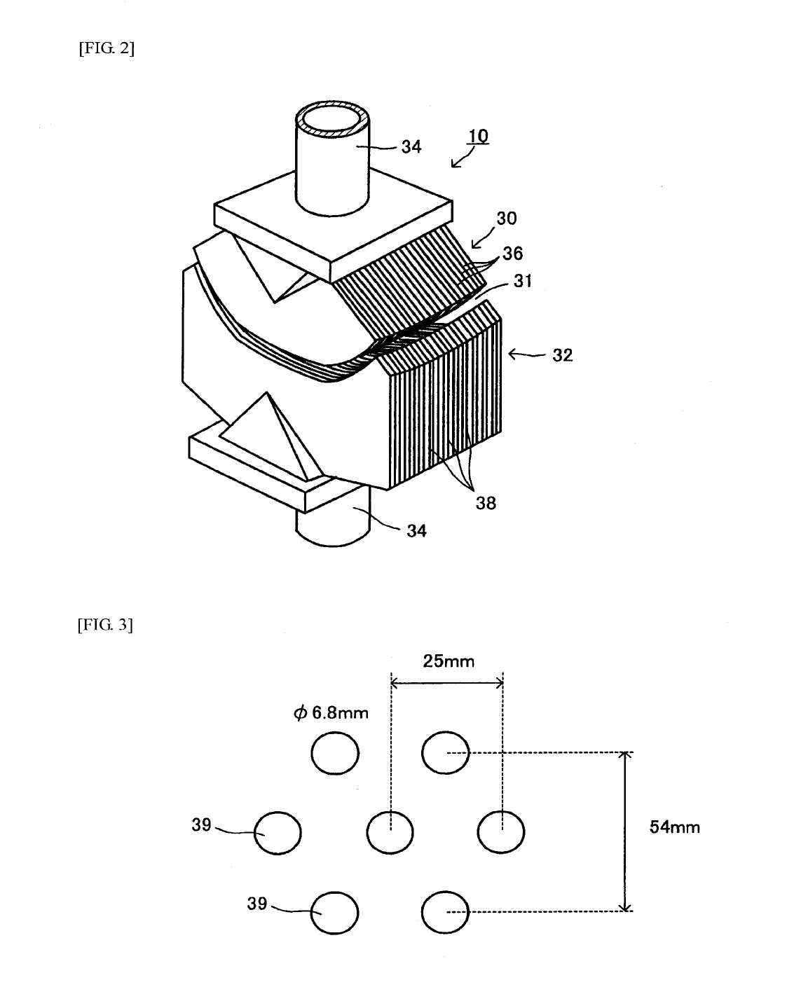

The glass plate G having finished undergoing bending and forming is transported into the strengthening device 10 utilizing air-cooling by the quench ring 66. As illustrated in FIG. 2, the strengthening device 10 utilizing air-cooling is provided with an upper nozzle member 30 sited upwardly across an air-cooling-strengthening area 31 from a lower nozzle member 32 sited downwardly. From FIG. 2 is omitted the glass plate G to be sandwiched between the upper nozzle member 30 and the lower nozzle member 32 at predetermined spacing.

A duct 34 is connected to each of the upper nozzle member 30 and the lower nozzle member 32, and to each duct 34 is connected a blower not illustrated. Thus, when the blower is driven, air generated by the blower is supplied to the upper nozzle member 30 and the lower nozzle member 32 via their respective ducts 34. And, as illustrated in FIG. 2, the air is made to blow in the air-cooling-strengthening area 31 illustrated in FIG. 2 from a plurality of cooling nozzles formed in the tip faces (lower faces in FIG. 2) of a plurality of blade-shaped members (i.e., nozzle chambers) 36, 36, . . . , which constitute the upper nozzle member 30, and from a plurality of cooling nozzles, not illustrated, formed in the tip faces (upper faces in FIG. 2) of a plurality of blade-shaped members (i.e., nozzle chambers) 38, 38, . . . , which constitute the lower nozzle member 32.

By such blowing, both surfaces of the glass plate G supported on the quench ring 66 are cooled and strengthened by air-cooling. The cooling process in the method for manufacturing a strengthened glass according to an embodiment is carried out by the use of, for example, such a strengthening device 10 utilizing air-cooling as mentioned above. The manufacturing method for a strengthened glass according to an embodiment allows a low velocity pressure of 30 kPa or below during the blowing of air, and hence the use of general strengthening devices utilizing air-cooling becomes possible.

The glass plate G strengthened by air-cooling with the strengthening device 10 utilizing air-cooling is transferred to an inspection process, which is not illustrated in the drawings, by the movement of the quench shuttle 60. In the inspection process, the glass plate G is inspected for defects including cracks and the like. The glass plate G in which no defects are found is transferred to a non-defective-item process. On the other hand, the glass plate G in which defects are found is transferred to a defective-item process.

### EXAMPLES

The present invention will be illustrated below in more detail by reference to the following Examples.

By the way, the present invention should not be construed as being limited to these Examples in any way.

Raw materials, such as oxides, to be generally used for making glass were chosen as appropriate, and weighed so as to make up any one of the compositions shown in Table 1 and Table 2 and to have a total weight of 300 g in a state of glass, and then mixed together. Thereafter, each mixture was placed in a platinum crucible, charged into a resistance-heating type electric furnace of 1,600° C., molten for 3 hours, and subjected to defoaming and homogenizing. After that, each of the homogenized mixtures was poured into a mold, kept for at least one hour at a temperature higher than its glass transition point by about 30° C., and annealed to room temperature at a cooling rate of 1° C. per minute. Thus plate-shaped glasses to be treated of Examples 1 to 15 were prepared. Herein, Examples 1 to 14 are examples according to the present invention, and Example 15 is a comparative example.

From each glass to be treated, a columnar sample having a diameter of 5 mm and a length of 20 mm was prepared in accordance with JIS R 3103-3:2001 standards, and thermal expansion thereof was measured by using a thermal dilatometer (TMA4000SA, a product of Bruker AXS K.K.) on conditions that the temperature rising rate was 5° C./min and the load was 10 g, and from the measurement data the transition point (Tg) was determined. From the same measurement data, the yield point (Ts) was also determined. By the way, the contents of JIS R 3103-3:2001 are incorporated herein by reference.

Furthermore, in accordance with JIS R 1618:2002 standards, thermal expansion measurement was made on each glass to be treated by using the same thermal dilatometer (TMA4000SA, a product of Bruker AXS K.K.) as used in the glass transition point measurement on condition that the temperature rising rate was 5° C./min, and therefrom were determined an average linear expansion coefficient a in a temperature range of 50° C. to 350° C. and a maximum thermal expansion coefficient αₘₐₓ in a temperature range between the glass transition point and the yield point. By the way, the contents of JIS R 1618:2002 are incorporated herein by reference.

For the purpose of evaluating easiness in strengthening each glass of Examples 1 to 15 by air-cooling, residual stress induced in a glass surface by the strengthening utilizing air-cooling was estimated by calculation. As assumed conditions for strengthening utilizing air-cooling were chosen that a glass plate thickness is 2.3 mm and a heating temperature (strengthening start temperature) is a temperature at which the viscosity η of each glass to be treated fell within a range of from 109.3 dPa·s to 109.5 dPa·s. As illustrated in FIG. 3, a plurality of cooling nozzles 39 were arranged in an alternate pattern, and the diameter of each cooling nozzle was set at 6.8 mm, the spacing between the centers of adjacent cooling nozzles in the horizontal direction was set at 25 mm, the spacing between the centers of adjacent cooling nozzles in the vertical direction (the spacing between the centers of adjacent cooling nozzles whose positions are the same in the horizontal direction) was set at 54 mm, the distance between the tip of each cooling nozzle and the surface of glass to be treated was set at 30 mm, the air temperature was set at 20° C., and the velocity pressure (velocity pressure of each nozzle) was set at 25 kPa.

TABLE 1

| | Ex. | Ex. | Ex. | Ex. | Ex. | Ex. | Ex. | Ex. |
|---|---|---|---|---|---|---|---|---|
| mol % | 1 | 2 | 3 | 4 | 5 | 6 | 7 | 8 |
| SiO₂ | 77.5 | 75.0 | 70.0 | 65.0 | 70.0 | 69.0 | 67.8 | 67.4 |
| Al₂O₃ | 0.0 | 0.0 | 0.0 | 0.0 | 0.0 | 1.0 | 2.9 | 5.0 |
| MgO | 0.0 | 0.0 | 0.0 | 0.0 | 0.0 | 5.0 | 4.0 | 3.0 |
| CaO | 0.0 | 0.0 | 0.0 | 0.0 | 0.0 | 7.0 | 6.0 | 4.0 |
| SrO | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 |
| Na₂O | 20.0 | 20.0 | 20.0 | 20.0 | 20.0 | 12.0 | 14.2 | 12.6 |
| K₂O | 0.0 | 0.0 | 0.0 | 0.0 | 0.0 | 1.0 | 0.1 | 3.0 |
| Fe₂O₃ | 2.5 | 5.0 | 10.0 | 15.0 | 0.0 | 5.0 | 5.0 | 5.0 |
| TiO₂ | 0.0 | 0.0 | 0.0 | 0.0 | 10.0 | 0.0 | 0.0 | 0.0 |
| Tg (° C.) | 488 | 490 | 482 | 489 | 560 | 565 | 568 | 557 |
| Ts (° C.) | — | 546 | 544 | 546 | 614 | 627 | 629 | 633 |
| α | 106 | 105 | 106 | 112 | 103 | 90 | 91 | 98 |
| (×10⁻⁷/° C.) | | | | | | | | |
| Δα | 527 | 719 | 759 | 786 | 573 | 744 | 742 | 704 |
| (×10⁻⁷/° C.) | | | | | | | | |
| αₘₐₓ | 633 | 824 | 865 | 898 | 676 | 834 | 833 | 802 |
| (×10⁻⁷/° C.) | | | | | | | | |
| Stress [MPa] | 153.0 | 182.3 | 189.6 | 197.5 | 158.0 | 176.6 | 176.9 | 175.5 |

TABLE 2

| | Ex. | Ex. | Ex. | Ex. | Ex. | Ex. | Ex. |
|---|---|---|---|---|---|---|---|
| mol % | 9 | 10 | 11 | 12 | 13 | 14 | 15 |
| SiO₂ | 62.4 | 66.8 | 66.8 | 64.0 | 60.0 | 63.0 | 69.3 |
| Al₂O₃ | 8.0 | 1.9 | 1.9 | 1.0 | 5.4 | 1.9 | 1.2 |
| MgO | 8.5 | 3.0 | 3.0 | 5.0 | 8.5 | 3.0 | 10.8 |
| CaO | 0.1 | 2.0 | 2.0 | 7.0 | 0.1 | 2.0 | 4.6 |
| SrO | 0.1 | 6.0 | 3.0 | 0.0 | 0.1 | 6.0 | 0.0 |
| BaO | 0.1 | 1.0 | 4.0 | 0.0 | 0.1 | 1.0 | 0.0 |
| Na₂O | 12.3 | 14.2 | 14.2 | 12.0 | 12.3 | 13.0 | 13.9 |
| K₂O | 3.5 | 0.1 | 0.1 | 1.0 | 3.5 | 0.1 | 0.2 |
| Fe₂O₃ | 5.0 | 5.0 | 5.0 | 0.0 | 0.0 | 0.0 | 0.1 |
| TiO₂ | 0.0 | 0.0 | 0.0 | 10.0 | 10.0 | 10.0 | 0.0 |
| Tg (° C.) | 575 | 522 | 505 | 638 | 630 | 604 | 545 |
| Ts (° C.) | 657 | 579 | 563 | 695 | 704 | 657 | 620 |
| α | 97 | 95 | 100 | 88 | 96 | 88 | 92 |
| (×10⁻⁷/° C.) | | | | | | | |
| Δα | 717 | 780 | 809 | 598 | 576 | 623 | 314 |
| (×10⁻⁷/° C.) | | | | | | | |
| αₘₐₓ | 814 | 874 | 908 | 686 | 672 | 710 | 406 |
| (×10⁻⁷/° C.) | | | | | | | |
| Stress [MPa] | 177.1 | 185.15 | 192.9 | 152.2 | 154.4 | 155.9 | 110.4 |

According to Examples 1 to 14, the strengthened glass according to the present invention had great residual stress (beyond 150 MPa) at its surface, and indicates that it has easiness of strengthening even in the case where the plate thickness thereof is thin.

### INDUSTRIAL APPLICABILITY

According to the strengthened glass of the present invention, a glass containing from 2% to 15% of Fe₂O₃ or from 5% to 15% of TiO₂ as expressed in mole percentage on an oxide basis and having a glass transition point in a range of from 450° C. to 650° C. and a maximum thermal expansion coefficient αₘₐₓ of 430×10⁻⁷/° C. or above in a temperature range between the glass transition point and a yield point is used as a glass to be treated, and thereby a strengthened glass having a plate thickness of 2.5 mm or below and a black hue can be manufactured through a general strengthening utilizing air-cooling without requiring any particular manufacturing equipment, and the strengthened glass having such a small plate thickness is valuable for use in not only transporting devices and buildings but also electronic devices.

The present invention has been illustrated in detail and by reference to specified embodiments, but it will be apparent to one skilled in the art that various changes and modifications can be made without departing from the spirit and scope of the present invention.

This application is based on Japanese Patent Application No. 2014-026810, filed on Feb. 14, 2014, the contents of which are incorporated herein by reference.

### DESCRIPTION OF REFERENCE NUMERALS AND SIGNS

G: Glass plate (glass plate to be treated)

10: Strengthening device utilizing air-cooling

12: Glass plate forming apparatus

14: Heating section

16: Roller conveyor

20: Forming furnace

22: Roller conveyor

24: Shaping die

25: Aspirating pipe

26: Bending ring

27: Bending ring supporting flame

28: Bending shuttle

29: Rail

30: Upper nozzle member

31: Air-cooling-strengthening area

32: Lower nozzle member

34: Duct

36: Member in blade form

38: Member in blade form

39: Cooling nozzle

60: Quench shuttle

62: Rail

64: Quench ring supporting flame

66: Quench ring

1. A strengthened glass obtained by strengthening a glass to be treated,
wherein the glass to be treated comprises, as expressed in mole percentage on an oxide basis, from 2% to 15% of Fe₂O₃ or from 5% to 15% of TiO₂, has a glass transition point of from 450° C. to 650° C. and has a maximum thermal expansion coefficient αₘₐₓ of 430×10⁻⁷/° C. or above in a temperature range between the glass transition point and a yield point.

2. The strengthened glass according to claim 1,
wherein the glass to be treated further comprises, as expressed in mole percentage on an oxide basis, from 55% to 80% of SiO₂, from 0 to 15% of Al₂O₃, from 0.1% to 10% of MgO, from 0.1% to 10% of CaO, from 0 to 8% of SrO, from 0 to 5% of BaO, from 8% to 25% of Na₂O, and from 0.1% to 4% of K₂O.

3. The strengthened glass according to claim 1,
wherein the glass to be treated comprises substantially no B₂O₃ and no Li₂O.

4. The strengthened glass according to claim 2,
wherein the glass to be treated comprises substantially no B₂O₃ and no Li₂O.

5. A glass to be treated for strengthening, comprises, as expressed in mole percentage on an oxide basis, from 55% to 80% of SiO₂, from 0 to 15% of Al₂O₃, from 0.1% to 10% of MgO, from 0.1% to 10% of CaO, from 0 to 8% of SrO, from 0 to 5% of BaO, from 8% to 25% of Na₂O, from 0.1% to 4% of K₂O, and further from 2% to 15% of Fe₂O₃ or from 5% to 15% of TiO₂.
